(19) United States
(12) Patent Application Publication
(10) Pub. No.: US 2026/0238064 A1
(43) Pub. Date: Aug. 13, 2026

(54) WIRING ASSEMBLY COMPRISING A POSITIONING DEVICE, USE OF THE POSITIONING DEVICE, AND METHOD FOR MOUNTING THE WIRING ASSEMBLY

(71) Applicant: ZF FRIEDRICHSHAFEN AG, Friedrichshafen (DE)

(72) Inventors: Tobias SCHRENK, Bad Neustadt an der Saale (DE); Marcel WERNER, Schonungen (DE); Christoph WIEDER, Küps (DE); Andreas HESLER, Sennfeld (DE); Roland LINDWURM, Sennfeld (DE); Sebastian BAUMGART, Bad Bocklet (DE); Katja WILLACKER, Wiesentheid (DE); Jochen WITTMANN, Burkardroth (DE); Johannes FISCHER, Fuchsstadt (DE)

(21) Appl. No.: 19/155,370

(22) PCT Filed: Feb. 7, 2024
(86) PCT No.: PCT/EP2024/052999

§ 371 Date: Aug. 11, 2025

(30) Foreign Application Priority Data
Feb. 14, 2023 (DE) 10 2023 201 223.5

(51) Int. Cl. H02K 3/50; H02K 15/33

(52) U.S. Cl. CPC H02K 3/50; H02K 15/33; H02K 2203/09

(57) ABSTRACT

An interconnection arrangement for an electric machine having a multiphase stator winding with at least one winding end per phase, the winding ends extend in an axial direction with reference to the stator axis, and an interconnection device having a connection unit for electrically contacting the winding ends with a high-voltage terminal and an electrically insulating insulation housing. The connection unit is partially in the insulation housing and has conductor portions that extend in the same direction as the winding ends and are electrically conductively contacted with at least one winding end in each instance. The interconnection arrangement has a positioning device for positioning the winding ends at the respective associated conductor portion. The positioning device is centered with respect to the interconnection device via a centering connection.

### CROSS REFERENCE TO RELATED APPLICATIONS

This is a U.S. national stage of Application No. PCT/EP2024/052999 filed Feb. 7, 2024. Priority is claimed on German Application No. DE 10 2023 201 223.5 filed Feb. 14, 2023, the contents of which are incorporated herein by reference.

### BACKGROUND OF THE INVENTION

### 1. Field of the Invention

The disclosure is directed to an interconnection arrangement. The disclosure is further directed to a use of the positioning device as transport safety and/or cutting-to-length aid and to a method for assembling the interconnection arrangement.

### 2. Description of the Related Art

Electric machines in which a stator winding of a stator is contacted with a high-voltage terminal, e.g., power electronics, by an interconnection arrangement in order to apply voltage to the individual phases of the stator winding are known. Due to installation space limitations, it is known from the prior art to arrange the interconnection arrangement outside of a housing of the electric machine rather than inside of the housing. For example, the interconnection arrangement can be axially fastened to a side of the housing remote of the stator.

Publication DE 10 2019 133 674 A1 discloses an electric machine comprising a rotor and a stator. The stator comprises a stator body which carries at least one respective winding of at least one phase. The winding of the respective phase, or at least one of the windings of the respective phase, is conductively connected to a respective contact bridge which connects the respective winding to an associated current source and/or current sink. The respective winding and the contact bridge connected thereto end, respectively, in a conductor portion which extends in axial direction of the electric machine away from the stator body, these conductor portions being conductively connected to one another. A fastening portion of the respective contact bridge is arranged stationary with respect to a housing receiving the stator in that it is fastened via an insulating element or directly to the housing itself on the one hand and/or, on the other hand, to the current source and/or current sink which is in turn fastened to the housing.

### SUMMARY OF THE INVENTION

It is an object of one aspect of the invention to provide an interconnection arrangement of the type mentioned above which is characterized by a simplified assembly.

The above-stated object is met by an interconnection arrangement, a use, and a method. Further inventive configurations and advantages will be apparent from the subclaims and the following description and appended drawings.

The subject matter of one aspect of the invention is an interconnection arrangement which is formed and/or suitable for an electric machine. In particular, the electric machine serves to generate an electric drive torque for a vehicle, particularly a traction torque. The electric machine is formed, for example, as a traction machine, as it is called. The electric machine can be integrated in an electric drivetrain, preferably an electric axle. The electric drivetrain can be an all-electric drivetrain or a hybrid drivetrain. The electric machine preferably has a stator and a rotor which is arranged radially inside of the stator and which defines a rotational axis. In other words, the electric machine is formed as an inrunner.

The interconnection arrangement has a multiphase stator winding which has at least one, or exactly one, winding end per phase. The winding ends extend in axial direction with reference to a stator axis. In particular, the stator winding has exactly three phase windings for contacting with power electronics, each phase winding comprising at least one partial strand. The phase windings can be interconnected with one another via star point contacting to form a star circuit. Each partial strand is preferably formed by a plurality of plug-in coils. The plug-in coils can have at least one, preferably exactly two, contact points on at least one side via which the plug-in coils are connected to one another pairwise to form the respective partial strand. The stator winding is preferably arranged at a stator body of the stator, and the stator body has a plurality of slots extending in each instance along a longitudinal axis, each plug-in coil running through at least one, preferably exactly two, slots which are spaced apart in circumferential direction. The stator winding is preferably formed as a hairpin winding or a wave winding. The plug-in coils can be formed as hairpins, I-pins or D-pins. The winding ends preferably extend parallel to and/or in the same direction as the stator axis. In particular, the winding ends protrude in axial direction from a winding head of the stator winding at least at an axial front side. Particularly preferably, the winding ends extend in axial direction at a radial inner diameter of the stator winding. In particular, the stator axis is defined by the rotational axis of the rotor.

The interconnection arrangement has an interconnection device which is formed and/or suitable particularly for the interconnection of the partial strands or plug-in coils. To this end, the interconnection device has a connection unit which is formed and/or suitable for electrically contacting the winding ends with a high-voltage terminal. in particular, the interconnection device is contacted with the stator winding via the connection unit. In a particularly preferable manner, the interconnection device is arranged in axial direction with respect to the rotational axis at a front side of the stator remote of the contact points. The interconnection device can be formed substantially arcuate, preferably as an annular segment. The high-voltage terminal is preferably formed as an AC high-voltage terminal of power electronics. In this regard, “high voltage” means an AC voltage above 30 V. The connection unit is preferably formed by a plurality of busbars which are electrically insulated from one another.

The interconnection device has an electrically insulating insulation housing in which the connection unit is at least partially received. In principle, the connection unit can be partially received in the insulation housing. Alternatively, the connection unit is partially embedded in the insulation housing. The insulation housing can be produced from any electrically insulating material, for example, plastics or ceramics. In particular, the connection unit is arranged in the insulation housing such that at least the areas of the connection unit electrically contacting the winding ends or high-voltage terminal are exposed.

The connection unit has a plurality of conductor portions that extend in axial direction and/or in the same direction as the winding ends and are electrically conductively contacted with the respective winding ends in radial direction with reference to the stator axis. In particular, viewed axially with reference to the stator axis, the winding ends are arranged radially inwardly of the conductor portions. In other words, the conductor portions are supported radially outwardly at the winding ends. Alternatively, the winding ends may be arranged radially outwardly of the conductor portions viewed axially with reference to the stator axis. In other words, the conductor portions are accordingly supported radially inwardly at the winding ends. Further, the connection unit can have at least one, or exactly one, further conductor portion for contacting at least one winding end, e.g., a neutral conductor. For example, the conducting portions are formed as winding terminal lugs. In a particularly preferable manner, it is provided that the winding ends are bondingly connected to the respective conductor portions. For example, the winding ends can be welded or soldered to the respective conductor portion.

It is suggested within the framework of the invention that the interconnection arrangement has a positioning device which is formed and/or suitable for positioning the winding ends in correct position at the respective associated conductor portion. The positioning device and the interconnection device are formed as two separate component parts which are centered and/or centerable in correct position with respect to one another via at least one, or exactly one, centering connection. The positioning device serves to capture the individual winding ends when the positioning device is mounted and to subsequently pre-align them relative to the respective conductor portions. When the interconnection device is mounted subsequently, the individual winding ends are aligned in such a way that the conductor portions abut the respective winding ends and/or can be contacted with the latter. In particular, the positioning device and the interconnection device are connected and/or connectable to one another via the at least one centering connection in exactly one unique orientation. The centering connection is preferably formed between the positioning device and the interconnection device. The positioning device and the interconnection device can be connected to one another in a positively engaging and/or frictionally engaging manner via the centering connection at least in radial direction and/or in tangential direction or in circumferential direction with reference to the stator axis.

One aspect of the invention is based on the recognition that the winding ends are axially lengthened for contacting the interconnection device, as a result of which the winding ends are exposed to the vibrations of the drivetrain and, due to dynamic loads on the contact points, can disengage particularly from the conductor portions. This leads to outage of the electric machine.

The advantage of one aspect of the invention consists in that the winding ends are supported and guided by the positioning device and are accordingly held in a predetermined final position. In this way, the winding ends are protected against the effects of drivetrain vibrations and, therefore, against the possibility of pulling off or disengaging from the respective conductor portions. Further, the positioning device serves as assembly aid, since the alignment of the winding ends appreciably facilitates mounting of the interconnection device at the winding ends.

In a particular aspect, it is provided that the centering connection is formed to align the positioning device relative to the interconnection device during assembly in radial direction and/or circumferential direction or tangential direction with reference to the stator axis, while the interconnection device is held fixed in place in the intended installation position, particularly via an assembly tool. In particular, the positioning device can be pre-mounted at the winding ends over the course of an assembly process in order to secure the winding ends during assembly and/or transport. In this regard, the position of the positioning device can deviate from the subsequent final position or an installation position in which the winding ends contact the respective associated conductor portion. Therefore, it is suggested that the interconnection device be secured in the subsequent installation position in the further assembly process so that the positioning device is aligned and centered in correct position with respect to the interconnection device via the centering connection. Accordingly, an interconnection arrangement is suggested which is characterized by a highly reliable assembly and a simplified assembly process.

In a particular aspect, it is provided that the centering connection is formed by a snap connection. In particular, the snap connection is formed in axial direction with respect to the stator axis between the positioning device and the interconnection device. The positioning device and the interconnection device are preferably centered relative to one another in radial direction and, optionally, in circumferential direction or tangential direction via the snap connection.

Alternatively or optionally additionally, the centering connection is formed by a positive engagement connection. In particular, the positive engagement connection is formed in radial direction and/or in circumferential direction or tangential direction with reference to the stator axis. A centering in radial direction and/or in circumferential direction or tangential direction is preferably carried out via the positive engagement connection.

Alternatively or optionally additionally, the centering connection is formed by a screw connection. In particular, the screw connection is formed in axial direction between the positioning device and the interconnection device. The positioning device and the interconnection device are preferably centered relative to one another in radial direction and in circumferential direction or tangential direction via the screw connection.

In a particularly preferable manner, the different connection variants can be combined with one another as desired in order to center the positioning device and the interconnection device relative to one another and possibly connect them to one another. For example, one connection variant can be used for centering in radial direction and the other connection variant can be used for centering in circumferential direction or in tangential direction. In particular, at least the snap connection and/or the positive engagement connection are formed by an insertion movement of the interconnection device relative to the positioning device. Optionally, the snap connection and/or the screw connection serve additionally for the axial connection of the interconnection device and positioning device. Accordingly, a centering connection is suggested which is realized in a particularly simple and cost-effective manner and which, at the same time, enables a simple assembly and centering of the two component parts.

In one aspect, it is provided that the snap connection is formed by at least one, or exactly one, snap hook which is formed at the positioning device and which engages with a snap contour formed at the insulation housing. Alternatively or optionally additionally, the snap connection is formed by at least one, or exactly one, snap hook formed at the insulation housing and which engages with a snap contour formed at the positioning device. The at least one snap hook and the at least one snap contour can be arranged at an outer diameter and/or at an inner diameter and/or at a circumferential end of the positioning device or interconnection device. The snap hook preferably contacts the snap contour selectively in radial direction or in circumferential direction or in tangential direction in order to center the interconnection device relative to the positioning device or to center the positioning device relative to the interconnection device. The snap hook preferably contacts the snap contour in axial direction with reference to the stator axis in order to captively secure the interconnection device at the positioning device or to captively secure the positioning device at the interconnection device. In particular, the snap hook is oriented in axial direction and is elastically deformable selectively in radial direction or in circumferential direction. In particular, the snap contour is formed by a protuberance, for example, a tab, a bar or the like, which is formed in radial direction and is hooked with the snap hook. Alternatively, the snap contour can also be formed as a recess, for example, a groove, an orifice or the like, which is inserted in radial direction and in which the snap hook engages. Particularly preferably, the snap hook and snap contour form a detachable snap connection. Accordingly, a centering connection is suggested which is characterized by a simple assembly and, at the same time, by a positively engaging connection of the two component parts.

In a further aspect, it is provided that the positive engagement connection is formed by at least one, or exactly one, positive engagement contour which is formed at the positioning device and which engages with a positive engagement receptacle formed at the insulation housing. Alternatively or optionally additionally, the positive engagement connection is formed by at least one, or exactly one, positive engagement contour which is formed at the insulation housing and which engages with a positive engagement receptacle formed at the positioning device. The at least one positive engagement contour and the at least one positive engagement receptacle can be arranged at an outer diameter and/or at an inner diameter and/or at a circumferential end of the positioning device or interconnection device. Alternatively, the positive engagement contour and the at least one positive engagement receptacle may also be formed at any other location. The positive engagement contour is preferably received in a positively engaging manner in the positive engagement receptacle in radial direction and/or in circumferential direction or tangential direction in order to center the interconnection device relative to the positioning device or to center the positioning device relative to the interconnection device. In particular, the positive engagement contour is formed by a bar, peg, pin or the like, and the positive engagement contour extends substantially in radial direction and/or in circumferential direction or tangential direction. In particular, the positive engagement receptacle is formed by a groove, orifice, recess or the like which is formed to complement the positive engagement contour. In particular, the interconnection device or the positioning device can have at least two, or exactly two, positive engagement contours, the one positive engagement contour serving to center in radial direction and the other positive engagement contour serving to center in circumferential direction. Optionally, it is provided that the positive engagement receptacle has an insertion bevel via which the positive engagement contour is centered when fitting into the positive engagement receptacle. Accordingly, a centering connection is suggested which is characterized by a particularly simple and robust centering.

In a further aspect, it is provided that the screw connection is formed by at least one, or exactly one, fastening receptacle arranged at the positioning device for receiving a fastener and at least one, or exactly one, fastening feedthrough formed at the insulation housing for feeding through the fastener. When installed as intended, the positioning device and the interconnection device are fastenable and/or fastened in common in a determined installation position at a housing, preferably a bearing shield, via the at least one fastener. The fastener is secured in the fastening receptacle, preferably detachably, preferably in a frictionally engaging and/or positively engaging manner. For example, the fastener is formed as a fastening screw, and the fastening receptacle correspondingly has an internal thread for receiving the fastening screw. The insulation housing and the positioning device preferably have a fastening bracket in each instance at the circumferential ends in which the fastening feedthrough or fastening receptacle is arranged. In particular, the housing, preferably the bearing shield, has at least one, or exactly one, fastening orifice for feeding through the fastener. In a particularly preferable manner, the fastening orifice, the fastening feedthrough and the fastening receptacle are arranged so as to be flush and/or congruent with one another in the installed position. In principle, a centering collar engaging with the fastening orifice can be arranged at the fastening receptacle in order to center the interconnection device relative to the positioning device. Alternatively, a centering collar engaging with the fastening receptacle can be arranged at the fastening orifice in order to center the positioning device relative to the interconnection device. Alternatively or optionally additionally, the centering can also be carried out by the fastener itself, and the fastener is received in a positively engaging manner in the fastening feedthrough for this purpose. Accordingly, an interconnection arrangement is suggested which is characterized by a particularly reliable assembly and fastening of the interconnection device.

In a further aspect, it is provided that the positioning device has a fixing portion for each conductor portion, via which fixing portion at least one, or exactly one, winding end is fixed in correct position relative to the respective associated conductor portion. In particular, the winding ends are fixed in a positively engaging and/or frictionally engaging manner via the fixing portions at least in radial direction and optionally in circumferential direction with reference to the stator axis. Particularly preferably, the winding ends are rectilinearly guided and/or positively guided in axial direction with reference to the stator axis by the respective fixing portion. To this end, the fixing portions are preferably formed in each instance as a guide channel, the respective winding end being partially guided through the associated guide channel in a positively engaging manner. In particular, the winding ends are supported or clamped in a positively engaging manner, preferably without play, in radial direction between the respective conductor portion and the guide channel in the assembled state of the interconnection device. Optionally additionally, the winding ends are supported in circumferential direction inside of the guide channel in a positively engaging manner, preferably without play. Accordingly, a positioning aid is suggested which ensures a play-free positioning of the winding ends at the respective conductor portions. In this way, the assembly process, particularly the process of joining the winding ends with the respective conductor portion, is appreciably simplified.

In one embodiment, it is provided that the positioning device has, in each instance, an insertion portion for every conductor portion, via which insertion portion the at least one winding end is inserted and/or insertable in correct position into the respective associated fixing portion. In particular, the winding ends are aligned in correct position via the insertion portions and inserted into the respective fixing portion when mounting the interconnection device. The insertion portion preferably serves to orient the individual winding ends radially and/or tangentially during the process of mounting the interconnection device. To this end, the fixing portion directly adjoins the insertion portion preferably without transition, and the winding ends are selectively guided via the contour of the insertion portion into the respective associated fixing portion. In particular, the insertion portion is configured in such a way that, during an assembly, all of the winding ends are received and subsequently inserted into the respective fixing portion by sliding the positioning device on axially. This further simplifies the assembly process in that the winding ends are pre-aligned during assembly.

Optionally, the fixing portion and/or the insertion portion have at least one, or exactly one, end stop which cooperates in axial direction with one of the winding ends and/or the stator winding, as a result of which an axial sliding on of the interconnection device is limited in the final position.

In a further development, it is provided that the insertion portions have an insertion opening in each instance, and the insertion portions substantially have a cross-sectional profile which converges from the insertion opening in direction of the fixing portion. In particular, the insertion portions are funnel-shaped in radial direction and/or in circumferential direction. In other words, the insertion portions have in each instance an opening diameter which decreases toward the fixing portion. As a result of the converging cross-sectional profile, large positional tolerances of the winding ends can be compensated in a particularly simple manner or the winding ends can be captured in a simple manner during assembly.

In a further specific realization, it is provided that the insertion portions have, in each instance, at least at a radially outer side, an inclined surface which runs obliquely, particularly from the insertion opening, in direction of the fixing portion, and which is formed and/or suitable for the insertion of the respective winding end in correct position in a radial direction. During an assembly, the winding ends can slide along the inclined surface, and the winding ends are simultaneously aligned radially in direction of the fixing portion. In particular, the inclined surface has a constant pitch angle. The inclined surface preferably has a pitch angle of greater than 10°, preferably greater than 20°, particularly greater than 30°. As a result of the configuration of the inclined surface at the radially outer side, the already existing radial installation space can be utilized in order to allow an insertion opening which is as large as possible. This ensures that the winding ends can be inserted easily and reliably into the respective fixing portion.

In a further aspect, it is provided that the insertion portions have, in each instance, at least one, or exactly one, obliquely extending further inclined surface in circumferential direction which is formed and/or suitable for the insertion of the respective winding end in correct position in circumferential direction or in tangential direction. During an assembly, the winding ends can slide along the further inclined surface and, at the same time, the winding ends are aligned tangentially in direction of the fixing portion at the same time. In principle, the further inclined surface can extend at a constant pitch angle in direction of the fixing portion proceeding from the insertion opening. Alternatively, the further inclined surface can extend at least partially inside of the respective insertion portion in direction of the fixing portion. As a result of the further insertion bevel, an additional alignment is made possible in circumferential direction or tangential direction of the individual winding ends during the assembly process.

Optionally, it is provided that the insertion portions have, in each instance, at a radially inner side a supporting surface which extends substantially axially from the insertion opening in direction of the fixing portion and which is formed and/or suitable for the radial support of the respective winding end. During an assembly, the winding ends can slide along the supporting surface axially in direction of the fixing portion. In particular, the supporting surface extends in axial extension of the respective guide channel such that the winding ends are inserted and/or insertable directly into the associated guide channel in axial direction when abutting the supporting surface. The supporting surface preferably extends in axial direction and/or in the same direction as and/or parallel to the respective conductor portion. In particular, the winding ends partially abut the supporting surface inside of the positioning aid in the final position. Optionally, it is provided that the insertion portion has at its radially inner side a lead-in chamfer extending from the insertion opening in direction of the supporting surface. Accordingly, a positioning aid is suggested which enables a particularly stable support of the individual winding ends.

A further aspect of the invention relates to a use of the positioning device according to the invention as transport safety for the winding ends and/or as cutting-to-length aid for the winding ends. In particular, the positioning device can be pre-mounted at the winding ends prior to assembling the interconnection device in order to secure the winding ends during transport and/or during an assembly process, particularly during a cutting-to-length step. For example, the positioning device used as transport safety serves to protect and/or support the lengthened winding ends. For example, the positioning device used as cutting-to-length aid serves as a visual cutting-to-length aid, and the fixing portions can be characterized by different lengths for different lengths of the winding ends. Accordingly, a positioning device is suggested which is characterized by a high functionality and, therefore, by a simplification of the assembly process. In addition, costs can be saved by the multiple use of the positioning device, particularly in transporting and assembly.

A further object of the invention relates to a method for assembling the interconnection arrangement as was previously described in which the stator winding is provided; the positioning device is pre-mounted at the winding ends, the winding ends being pre-aligned by the positioning device; and the interconnection device and positioning device are connected to one another in axial direction with reference to the stator axis and are centered in correct position relative to one another via the at least one centering connection. In particular, the positioning device is pre-mounted at the stator winding over the course of a stator assembly and the interconnection device is mounted at the pre-mounted positioning device over the course of a final assembly. The centering connection is preferably produced when the interconnection device is fitted to the positioning device. In a further assembly step, the positioning device and the interconnection device can be secured together at the housing, particularly the bearing shield, in the installation position.

In a specific implementation, it is provided that the interconnection device is held correctly positioned in an intended installation position during assembly by an assembly tool, the positioning device being centered relative to the interconnection device in the installed position via the centering connection. The interconnection device is preferably held relative to the stator in a stationary manner in the installation position in radial direction and/or in circumferential direction with reference to the stator axis, and the positioning device and interconnection device are moved in axial direction relative to one another.

In a further aspect, it is provided that the winding ends are shortened to a length required for the further steps after the positioning device is mounted or before the interconnection device is mounted. In a further or alternative method step, the winding ends are bondingly connected, preferably welded or soldered, to the conductor portions after the assembly of the interconnection device.

### BRIEF DESCRIPTION OF THE DRAWINGS

The present invention will be further described in the following referring to the drawings. The drawings show:

FIG. 1 is a detail perspective illustration of an interconnection arrangement for an electric machine;

FIG. 2 is a detail perspective illustration of a stator with a pre-mounted positioning device of the interconnection arrangement from FIG. 1;

FIG. 3 is a perspective view of an underside of the positioning device in the pre-mounted state;

FIG. 4 is a three-dimensional view of a centering connection of the interconnection arrangement from FIG. 1 formed between an interconnection device and the positioning device;

FIG. 5 is a sectional view through the centering connection from FIG. 4;

FIG. 6 is a three-dimensional view of the interconnection device with a further configuration variant of the centering connection;

FIG. 7 is a sectional view through the centering connection from FIG. 6;

FIG. 8 is a sectional view through the interconnection device and the positioning device with the centering connection; and

FIG. 9 a sectional view through the centering connection from FIG. 8.

### DETAILED DESCRIPTION OF THE PRESENTLY PREFERRED EMBODIMENTS

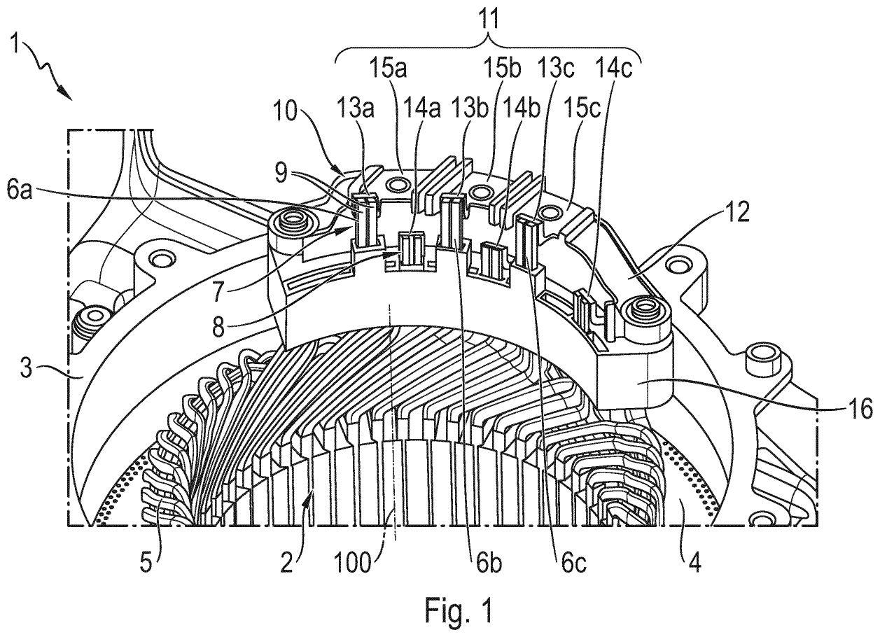

FIG. 1 shows an interconnection arrangement 1 for an electric machine which serves to generate an electric drive torque, particularly a traction torque, for an electric axle of a vehicle. The electric machine is formed as an inrunner and has a stator 2 and a rotor, not shown, arranged radially inside of the stator 2. The interconnection arrangement 1 of the electric machine has a housing 3. The stator 2 is pre-mounted in the housing 3 coaxially with reference to a stator axis 100.

The stator 2 is substantially formed of a stator body 4 and a multiphase stator winding 5. The stator body 4 supports the stator winding 5. To this end, the stator body 4 has a plurality of slots which are distributed in circumferential direction and extend in axial direction with reference to the stator axis 100. The stator winding 5 is formed, for example, by a plurality of plug-in coils, for example, in the form of hairpins or I-pins, which are interconnected with one another in a determined pattern. The plug-in coils are arranged in the slots, a plurality of plug-in coils being arranged per slot. The stator winding 5 has exactly three phase windings 6a, 6b, 6c with two winding ends 7, 8, respectively, which extend parallel to and/or in the same direction as one another in axial direction with respect to a stator axis 100 at an inner diameter of the stator winding 2. The phase windings 6a, 6b, 6c, respectively, comprise two partial strands 9 which are formed in each instance by a plurality of plug-in coils.

The interconnection arrangement 1 further has an interconnection device 10 for interconnecting the winding ends 7, 8 to form a star circuit which is substantially formed of a connection unit 11 and an insulation housing 12.

The winding ends 7, 8 are electrically conductively connected in each instance to the connection unit 11. To this end, the connection unit 11 has, in each instance, a conductor portion 13a, 13b, 13c for contacting the first winding ends 7 and, in each instance, a further conductor portion 14a, 14b, 14c for contacting the second winding ends 8. The interconnection device 10 is arranged outwardly of the winding ends 7, 8 in radial direction with reference to the stator axis 100 and is supported at the respective winding ends 7, 8 via the conductor portions 13a-c, 14a-c. For example, the winding ends 7, 8 can be nondetachably connected to the respective associated conductor portions 13a-c, 14a-c bondingly, preferably by a welding connection. The conductor portions 13a, 13b, 13c and the further conductor portions 14a, 14b, 14c are formed, respectively, as winding terminal lugs which extend in axial direction with reference to the stator axis 100 or in the same direction as the respective winding ends 7, 8.

The connection unit 11 further has, in each instance, per phase winding 6a, 6b, 6c, a contact portion 15a, 15b, 15c to form a high-voltage connection. For example, contact portions 15a, 15b, 15c serve for the electrical connection of power electronics. Contact portions 15a, 15b, 15c are formed, respectively, as an outer terminal lug which extends in a radial direction with reference to the stator axis 100 or in a radial plane of the stator axis 100.

The connection unit 11 is partially received in the insulation housing 12. Conductor portions 13a, 13b, 13c, further conductor portions 14a, 14b, 14c and contact portions 15a, 15b, 15c are accessible and exposed. For example, a contact portion 15a, 15b, 15c is electrically conductively connected in each instance with one of the conductor portions 13a, 13b, 13c via a busbar in each instance. The further conductor portions 14a, 14b, 14c are electrically conductively connected with one another via a switching ring, and the star point at which the second winding ends 8 of the three phase windings 6a, 6b, 6c are contacted with one another is formed by the switching ring. The busbars and the switching ring can be received or embedded in the insulation housing 12 so as to be electrically insulated from one another.

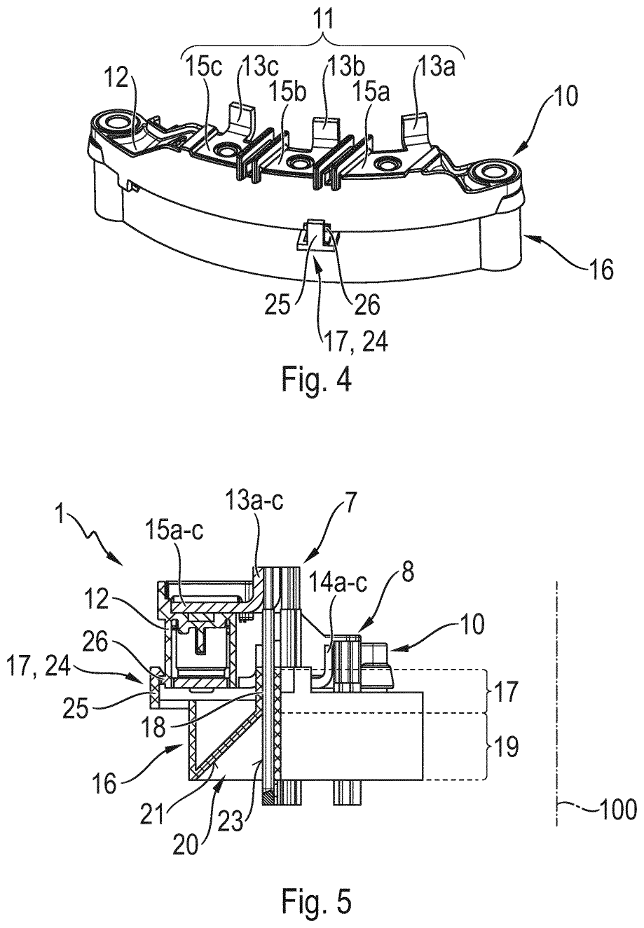

The interconnection arrangement 1 further has a positioning device 16 which serves to position the winding ends 7, 8 in correct position at the respective associated conductor portion 13a-c, 14a-c. To this end, the positioning device 16 is connected to the insulation housing 12 via at least one centering connection 17 as described referring to FIGS. 4 to 9 and is centered relative to the interconnection device 10. The winding ends 7, 8 are guided to the respective conductor portion 13a-c, 14a-c so as to be correctly positioned via the positioning device 16. The winding ends 7, 8 are supported and clamped in in radial direction between the respective associated conductor portion 13a-c, 14a-c and the positioning device 16. The insulation housing 12 and the positioning device 16 are fashioned in each instance from an electrically insulating material, for example, plastic.

The winding ends 7, 8 are axially lengthened for contact with the interconnection device 10. Accordingly, they are exposed to the vibrations of the drivetrain and can detach as a result of dynamic loads on the contact points of the respective conductor portions 13a-c, 14a-c, which leads to outage of the electric machine. The suggested positioning device 16 serves to protect the winding ends 7, 8 against the effects of vibrations of the drivetrain and, therefore, against a possible detachment at the contact points. Further, the positioning device 16 can serve as a transport safety and as assembly safety as will be described in the following.

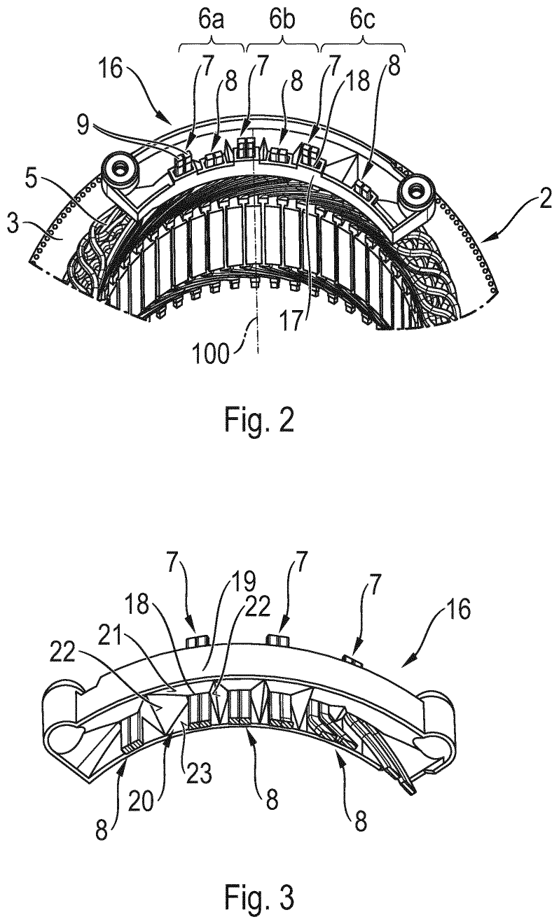

FIG. 2 shows the stator 2 with the pre-mounted positioning device 16 which is used as transport safety for the winding ends 7, 8 and/or as cutting-to-length aid for the winding ends 7, 8. The winding ends 7, 8 exit from a winding head of the stator winding 2 in axial direction with reference to the stator axis 100 and are captured via the positioning device 16.

For this purpose, the positioning device 16 has, per conductor portion 13a-c, 14a-c, a fixing portion 17 in each instance by which the winding ends 7, 8 of the respective phase winding 6a-c are guided in each instance. Therefore, in the present example, the positioning device 16 has three fixing portions 17 which respectively receive the first winding ends 7 of the respective phase winding 6a, 6b, 6c and three fixing portions 17 which respectively receive the second winding ends 8 of the respective phase winding 6a, 6b, 6c. Two partial strands 9 are received per fixing portion 17.

The fixing portions 17 serve in each instance to fix the winding ends 7, 8 in radial direction and in circumferential direction with reference to the stator axis 100. To this end, the fixing portions 17 are formed in each instance by a guide channel 18 through which the winding ends 7, 8 are rectilinearly guided in axial direction with reference to the stator axis 100. The winding ends 7, 8 are partially supported in a positively engaging manner inside of the guide channel 18 in radial direction and in circumferential direction with reference to the stator axis 100.

FIG. 3 shows an underside of the positioning device 16 before being mounted on the winding ends 7, 8. The positioning device 16 has, per fixing portion 17, an insertion portion 19 in each instance on the side facing the winding head, which insertion portion 19 serves as an aid for inserting winding ends 7, 8 into the respective associated fixing channel 18 when mounting the positioning device 16. The winding ends 7, 8 can undergo a change of position via the insertion portions 19 and can therefore be exactly aligned to the connection points of the interconnection device 10. In so doing, manufacturing tolerances of the winding ends 7, 8 are also compensated. The tolerance compensation is carried out in the two spatial directions that are not the insertion direction.

For this purpose, the insertion portions 19 have in each instance an insertion opening 20 via which the winding ends 7, 8 are insertable. Further, the insertion portions 19 have an inclined surface 21 in each instance at the radially outer inner side, which inclined surface 21 facilitates insertion of the winding ends 7, 8 in correct position in radial direction, and two further inclined surfaces 22 opposite one another in circumferential direction which facilitate insertion of the winding ends 7, 8 in correct position in circumferential direction or in tangential direction. The inclined surfaces 21, 22 extend with a constant pitch angle in direction of the guide channel 18, particularly proceeding from the insertion opening 20. The inclined surfaces 22, 23 can have different pitch angles and/or different pitch lengths. Further, the insertion portions 19 have in each instance a supporting surface 22 opposite the inclined surface 21 for the radial support of the winding ends 7, 8 which extends parallel to and/or in the same direction as the stator axis 100 or the respective winding end 7, 8. The supporting surfaces 22 form an axial lengthening of the respective guide channel 18.

The insertion openings 20 have an opening diameter which is greater by a multiple than the guide channel 18, and the insertion portions 19 through the inclined surfaces 21, 22 have a cross-sectional profile converging from the insertion opening 20 in direction of the fixing portion 19. As result of the funnel shape formed in this way, the winding ends 7, 8 can be captured in a simple manner during an assembly of the interconnection device 7 and can be aligned in correct position relative to the respective conductor portion 13a-c, 14a-c.

Accordingly, as a result of the insertion portions 19, the winding ends 7, 8 which deviate from a final position because of manufacturing-related tolerances can be captured and aligned in a simple manner so that the assembly of the interconnection device 10 is facilitated and the tolerances of the winding ends 7, 8 can be selected in a substantially less exacting manner. Further, because the winding ends 7, 8 are fixed in the fixing portions 17, the mechanical characteristics, e.g., vibratory loads, can be improved. Further, the positioning device 16 forms a mechanical protection of the winding ends 7, 8 during handling and assembly.

FIGS. 4 to 9 show different constructions of the centering connection 17. The centering connections 17, individually or in combination with one another, are formed between the interconnection device 10 and the positioning device 16. To produce the interconnection arrangement 1, the positioning device 16 is initially fitted to the lengthened winding ends 7, 8 as is shown in FIGS. 2 and 3, which occupy a position in which they are pre-aligned in correct position with respect to the conductor portions 13a-c, 14a-c of the interconnection device 10 to be applied subsequently. In this state, the stator 2 can be safely transported in that the lengthened winding ends 7, 8 are supported by the positioning device 16.

However, the final position of the positioning device 16 may deviate from a subsequent ideal installation position. Therefore, in order to produce the centering connections 17, it is provided that the interconnection device 10 is already positioned in the ideal installation position and held there by an assembly tool during the assembly process at the beginning of the assembly process, the positioning device 16 being aligned in correct position and centered in the installation position via the centering connection 17 at the interconnection device 10. Accordingly, the positioning device 16 and the winding ends 7, 8 received therein undergo a change of position which effects a definitive clamping of the winding ends 7, 8 in the fixing portions 17.

Subsequently, the conductor portions 13a-c, 14a-c of the interconnection device 10 can be welded to the respective associated winding ends 7, 8 as part of a joining process. In so doing, the positioning device 16 can also be used prior to the joining process as an aid for cutting the winding ends 7, 8 to length. As it relates to the assembly process, this means that the winding ends 7, 8 are shortened to the length required for the further assembly steps after the pre-mounting of the positioning device 16 as is shown in FIGS. 2 and 3. For example, the positioning device 16 serves as a visual cutting-to-length aid in that the fixing portions 18 have different heights in axial direction.

FIGS. 4 and 5 show a first possible construction of the centering connection 17 formed between the interconnection device 10 and the positioning device 16. The centering connection 17 is formed by a snap connection 24, for which purpose the positioning device 16 has a snap hook 25 which cooperates with a snap contour 26 formed at the insulation housing 12 of the interconnection device 10. The snap hook 25 and the snap contour 26 are arranged, respectively, at an outer diameter of the positioning device 16 or insulation housing 12, the snap connection 24 being formed in axial direction with reference to the stator axis 100.

As is shown in FIG. 5, the snap hook 25 extends in axial direction with reference to the stator axis 100. The snap hook 25 is elastically deformable in radial direction with reference to the stator axis 100. The snap contour 26 is formed as a protuberance molded onto the insulation housing 12, for example, a locking tab, which is oriented in radial direction. The interconnection device 10 and the positioning device 16 are moved in axial direction relative to one another with reference to the stator axis 100 in order to produce the snap connection 24, the snap hook 25 being radially deflected and hooking with the snap contour 26 in a correct final position of the interconnection device 10 and positioning device 16. In so doing, the snap hook 25 contacts the insulation housing 12 in radial direction for radially centering the interconnection device 10 relative to the positioning device 16. Further, the snap hook 25 contacts the snap contour 26 in axial direction in order to fix the interconnection device 10 to the positioning device 16 in axial direction.

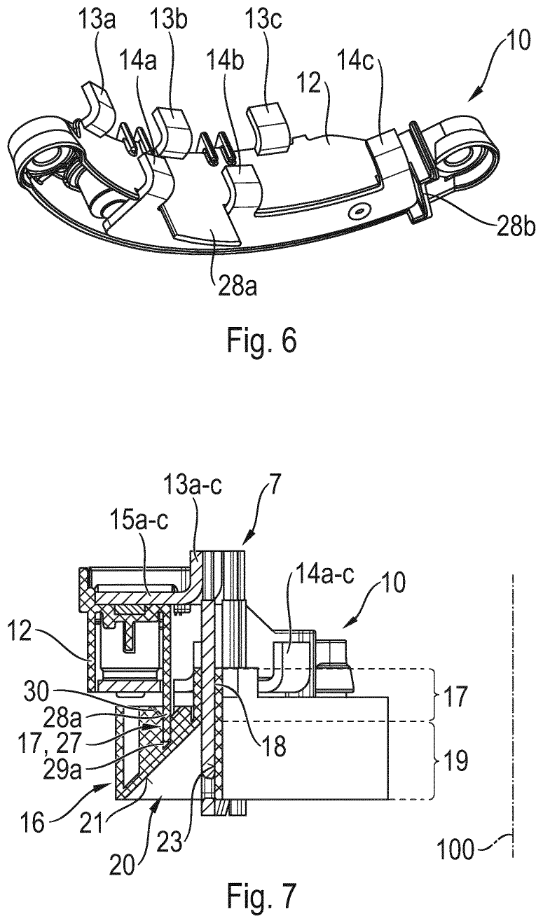

FIGS. 6 and 7 show a second possible construction of the centering connection 17 formed between the interconnection device 10 and the positioning device 16. The centering connection 17 is formed here by a positive engagement connection 27, for which purpose the insulation housing 12 has two positive engagement contours 28a, 28b which are molded onto a side facing the positioning device 16. The first positive engagement contour 28a extends in circumferential direction partially at an inner diameter of the insulation housing 12 in order to form a positive engagement connection 27 in radial direction. The second positive engagement contour 28b extends substantially in radial direction at one of the circumferential ends of the insulation housing 12 in order to form a positive engagement connection 27 in circumferential direction or tangential direction.

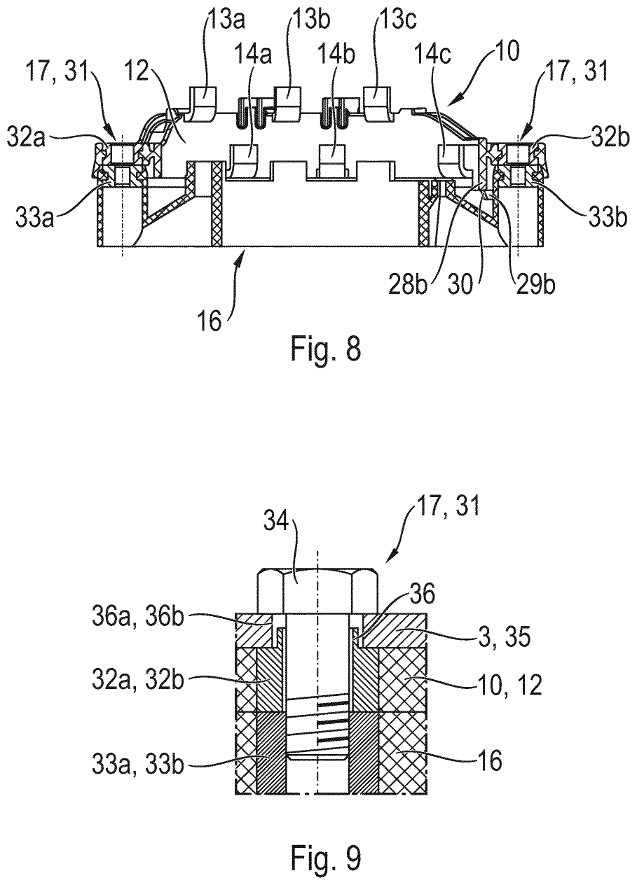

As is shown in FIGS. 7 and 8, the positioning device 16 has a positive engagement receptacle 29a, 29b complementing the positive engagement contours 28a, 28b, respectively. The first positive engagement contour 28a is received in a positively engaging manner in the first positive engagement receptacle 29a at least in radial direction with reference to the stator axis 100 in order to center the positioning device 16 in radial direction at the interconnection device 10. The second positive engagement contour 28b is received in a positively engaging manner in the second positive engagement receptacle 29 at least in circumferential direction with reference to the stator axis 100 in order to center the positioning device 16 in circumferential direction at the interconnection device 10. The positive engagement connection is formed, for example, by a keyed joint, with the first and/or second positive engagement contour 28a, 28b formed as key and the respective positive engagement receptacle 29a, 29b formed as a corresponding slot.

Further, the first positive engagement receptacle 29a and second positive engagement receptacle 29b can have an insertion bevel 30 in each instance which forms an insertion aid for the respective positive engagement contour 28a, 28b. In order to produce the positive engagement connection 24, the interconnection device 10 and the positioning device 16 are moved relative to one another in axial direction with reference to the stator axis 100, and positive engagement contours 28a, 28b are inserted into the respective positive engagement receptacle 29a, 29b via the insertion bevels 30.

FIGS. 8 and 9 show a third possible construction of the centering connection 17 formed between the interconnection device 10 and the positioning device 16. The centering connection 17 is formed by a screw connection 31. For this purpose, the interconnection device 10 has two fastening feedthroughs 32a, 32b arranged at the circumferential ends of the insulation housing 12, and the positioning device 16 has two fastening receptacles 33a, 33b arranged at the circumferential ends. The insulation housing 10 and the positioning device 16 have a fastening bracket in each instance at the circumferential ends, the fastening feedthroughs 32a, 32b and fastening receptacles 33a, 33b, respectively, being mounted therein so as to be fixed with respect to rotation relative to it.

As is shown in FIG. 9, a fastening element 34 is guided through the fastening feedthroughs 32a, 32b in each instance for centering via the screw connection 31 and is received in the respective associated fastening receptacle 33a, 33b. The fastener 34 may be formed as screws, in which case the fastening receptacles 33a, 33b have a corresponding inner thread into which the screw is screwed.

By way of example, the interconnection device 10 and the positioning device 16 can be fastened to the housing 3, particularly to a bearing shield 35 of the electric machine, via the fastener 34. The interconnection device 10 is arranged and fixed in this case so as to be sandwiched between the bearing shield 35 and the positioning device 16. For each fastening feedthrough 32a, 32b and fastening receptacle 33a, 33b, the bearing shield 35 has a fastening orifice 36a, 36b through which the respective associated fasteners 34 are guided. The fastening orifices 36a, 36b are formed in each instance as through-bores which are aligned flush and/or congruent with the fastening feedthroughs 32a, 32b and fastening receptacles 33a, 33b in a positionally correct final position or installation position of the interconnection device 10.

In order to produce the screw connection 24, the fasteners 34 are guided from the outside via the fastening orifices 36a, 36b and fastening feedthroughs 32a, 32b and mounted in the fastening receptacles 33a, 33b. The fasteners 34 are received in a positively engaging manner at least in the fastening feedthroughs 32a, 32b in order to center the positioning device 16 in circumferential direction and in radial direction at the interconnection device 10. Optionally, the fastening feedthroughs 32a, 32b have a centering collar 36 in each instance which engages in a positively engaging manner in the respective associated fastening orifice 36a, 36b in the positionally correct installation position of the interconnection device 10 in order to center the interconnection device 10 at the bearing shield 35.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-15. (canceled)

16. An interconnection arrangement for an electric machine, with a multiphase stator winding, which has at least one winding end per phase, wherein the winding ends extend in an axial direction with reference to a stator axis, an interconnection device comprising:
an insulation housing that is electrically insulating;
a connection unit arranged at least partially in the insulation housing and configured to electrically contact the winding ends with a high-voltage terminal, wherein the connection unit has a plurality of conductor portions which extend in a same direction as the winding ends and are electrically conductively contacted with at least one winding end in each instance;
a positioning device configured to position the winding ends in a correct position at a respective associated conductor portion; and
at least one centering connection configure to center the positioning device in the correct position with respect to the interconnection device.

17. The interconnection arrangement according to claim 16, wherein the centering connection is configured to align the positioning device relative to the interconnection device in radial direction and/or in tangential direction with reference to the stator axis, wherein the interconnection device is held fixed in place in a final position.

18. The interconnection arrangement according to claim 16, wherein the centering connection is formed by a snap connection and/or a positive engagement connection and/or a screw connection.

19. The interconnection arrangement according to claim 18,
wherein the centering connection is formed by a snap connection; and
wherein the snap connection is formed by at least one snap hook which is formed at the positioning device and which engages with a snap contour formed at the insulation housing, and/or the snap connection is formed by at least one snap hook which is formed at the insulation housing and which engages with a snap contour formed at the positioning device.

20. The interconnection arrangement according to claim 18,
wherein the centering connection is formed by a positive engagement connection; and
wherein the positive engagement connection is formed by at least one positive engagement contour which is formed at the positioning device and which engages with a positive engagement receptacle formed at the insulation housing, and/or the positive engagement connection is formed by at least one positive engagement contour which is formed at the insulation housing and which engages with a positive engagement receptacle formed at the positioning device.

21. The interconnection arrangement according to claim 18,
wherein the centering connection is formed by a screw connection; and
wherein the screw connection is formed by at least one fastening receptacle arranged at the positioning device for receiving a fastener and at least one fastening feedthrough formed at the insulation housing for feeding through the fastener, wherein the positioning device and the interconnection device are fastenable to a housing via the at least one fastener.

22. The interconnection arrangement according to claim 16, wherein the positioning device has a fixing portion for each conductor portion, via which fixing portion at least one winding end is fixed in correct position relative to the respective associated conductor portion.

23. The interconnection arrangement according to claim 22, wherein the positioning device has, in each instance, an insertion portion for every conductor portion, via which insertion portion the at least one winding end is insertable in correct position into the respective associated fixing portion.

24. The interconnection arrangement according to claim 23, wherein the insertion portions have an insertion opening in each instance, wherein the insertion portions substantially have a cross-sectional profile which converges from the insertion opening in direction of the fixing portion.

25. The interconnection arrangement according to claim 24, wherein the insertion portions have in each instance, at least at a radially outer side, an inclined surface which runs obliquely in direction of the fixing portion for the insertion of the respective winding end in correct position in a radial direction.

26. The interconnection arrangement according to claim 25, wherein the insertion portions have in each instance at least one obliquely extending further inclined surface in circumferential direction for the insertion of the respective winding end in correct position in circumferential direction.

27. The interconnection arrangement according to claim 16 configured as a transport safety for the winding ends and/or as a cutting-to-length aid for the winding ends.

28. A method for assembling an interconnection arrangement having an insulation housing that is electrically insulating; a connection unit arranged at least partially in the insulation housing and configured to electrically contact winding ends with a high-voltage terminal, wherein the connection unit has a plurality of conductor portions which extend in a same direction as the winding ends and are electrically conductively contacted with at least one winding end in each instance; a positioning device configured to position the winding ends in a correct position at a respective associated conductor portion; and at least one centering connection configure to center the positioning device in the correct position with respect to an interconnection device, comprising:
providing a stator winding;
pre-mounting the positioning device at the winding ends, wherein the winding ends are pre-aligned by the positioning device; and
connecting the interconnection device and the positioning device to one another in axial direction with reference to a stator axis and are centered in correct position relative to one another via the at least one centering connection.

29. The method according to claim 28, wherein the interconnection device is held correctly positioned in an intended installation position during assembly by an assembly tool, wherein the positioning device is centered relative to the interconnection device in the installed position via the centering connection.

30. The method according to claim 28, wherein the winding ends are shortened to a length required for further steps after the assembly of the positioning device, and/or the winding ends are bondingly connected to the conductor portions after the assembly of the interconnection device.
